(19) United States
(12) Patent Application Publication
(10) Pub. No.: US 2026/0023188 A1
(43) Pub. Date: Jan. 22, 2026

(54) METHOD FOR CORRECTING AN X-RAY IMAGE, PROCESSING APPARATUS, X-RAY FACILITY, COMPUTER PROGRAM, AND DATA CARRIER

(71) Applicant: Siemens Healthineers AG, Forchheim (DE)

(72) Inventors: Philipp Bernhardt, Forchheim (DE); Niko Köster, Neunkirchen am Brand (DE)

(21) Appl. No.: 19/273,123

(22) Filed: Jul. 17, 2025

(30) Foreign Application Priority Data
Jul. 18, 2024 (DE) 10 2024 206 759.8

(51) Int. Cl. G01T 1/29; G01T 1/08

(52) U.S. Cl. CPC G01T 1/2992; G01T 1/08

(57) ABSTRACT

A method for correcting an X-ray image that is based on imaging during a first time interval and indicates a respective X-ray image value for at least one image point includes receiving a plurality of dark images. A respective dark image is based on image data capturing during a respective subinterval of a second time interval preceding the first time interval, during which no X-rays are irradiated onto an X-ray detector, and indicates a respective dark image value for the respective image point. A respective afterglow value is predicted for the respective image point in the X-ray image, in dependence on the dark image values of a plurality of the dark images for the respective image point. The X-ray image is corrected by ascertaining a respective corrected X-ray image value for the respective image point in dependence on the respective X-ray image value and the respective afterglow value.

This application claims the benefit of German Patent Application No. DE 10 2024 206 759.8, filed on Jul. 18, 2024, which is hereby incorporated by reference in its entirety.

### BACKGROUND

The present embodiments relate to correcting an X-ray image.

Digital flat panel detectors are currently the most common type used in X-ray based medical imaging. Depending on their design, these may exhibit a more or less pronounced afterglow behavior. This results from the fact that charges accumulating, for example, in defective areas of the scintillator or the sensor's photodiode following prior X-radiation are only released over time, thereby influencing image values at subsequent points in time. The effect is particularly pronounced when a high-dose image is followed by a low-dose image. In this case, it is, for example, possible for highly exposed structures from the high-dose image to be mapped in the low-dose image even if the highly exposed structures are not actually present in the mapped area.

To date, for example, in fluoroscopy applications, ongoing exposure series are interrupted several times in order to record a respective dark image that is used to correct the X-ray images recorded in the time interval around the dark image. However, this approach leads to a number of disadvantages.

The dark images contain electrical noise, whereby the signal-to-noise ratio is worsened by subtracting the dark image in the corrected images. This may make it necessary to use higher X-ray doses and thus increase the patient's exposure.

Recording dark images requires time that is lost for the actual exposure or requires the pulse frequency of the exposure pulses to be temporarily reduced. Therefore, the application of this correction approach leads to lower dose efficiency and/or reduced temporal resolution of the imaging.

The publication Starman, J., et al. (2012), A nonlinear lag correction algorithm for a-Si flat-panel x-ray detectors. Med. Phys., 39:6035-6047, https://doi.org/10.1118/1.4752087, discloses removing afterglow from previous images during an X-ray sequence by deconvolution of the measured data. The use of a non-linear model of the afterglow is proposed, where the weighting and the decay rate of previous image values depends on the irradiated X-ray dose in each case. This approach may at least largely compensate afterglow on a short time scale, as typically occurs with the irradiation of low to medium X-ray doses. However, longer afterglow on a time scale of a number of minutes or even more than an hour often occurs in connection with saturation of the detector element and thus of the image value. Since the actually irradiated X-ray dose cannot be clearly reconstructed during such saturation, long-lasting afterglow effects cannot usually be compensated by the described deconvolution, or, at best, the long-lasting afterglow effects may only be compensated to a small extent.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, an improved approach for afterglow correction in X-ray images is provided.

A computer-implemented method includes receiving an X-ray image and receiving a plurality of dark images. The respective dark image is based on respective image data capturing by the X-ray detector during a respective subinterval of a second time interval preceding the first time interval, during which no X-rays are irradiated by the X-ray source onto the X-ray detector, and indicates a respective dark image value for the respective image point. The computer-implemented method includes predicting a respective afterglow value for the respective image point in the X-ray image that is expected as the X-ray image value in the event that no X-rays from the X-ray source are incident on a respective detector element of the X-ray detector assigned to the respective image point even after the second time interval, in dependence on the dark image values of a plurality of the dark images for the respective image point. The computer-implemented method includes correcting the X-ray image by ascertaining a respective corrected X-ray image value for the respective image point in dependence on the respective X-ray image value and the respective afterglow value.

Taking account of a plurality of dark images preceding the same X-ray recording enables the temporal profile of the decay of the afterglow and thus the afterglow value at the point in time or in the time interval of the new recording to be predicted (e.g., by software) and used for correction. In one embodiment, it is, for example, possible to take advantage of the fact that the X-ray source is often deactivated for a certain period of time (e.g., a number of seconds, tens of seconds, or even more than a minute) between imaging sequences or between separate partial sequences of a longer imaging sequence. During such an interval, a plurality of dark images may be captured, and thus, the temporal development of the image values of the individual image points in the dark images and thus the decay profile of the afterglow may be characterized with high accuracy without having to modify the imaging sequence itself. Although, as will be discussed later, various processes may be involved in the afterglow of the X-ray detector, providing that the decay of the afterglow depends on the previous history of the detector or the irradiation of X-rays thereonto, the prediction may thus be made with a high degree of accuracy.

The X-ray image may, for example, be corrected by subtracting the respective afterglow value from the respective X-ray image value. However, it is also possible to scale the X-ray image value in dependence on the afterglow value or to ascertain the corrected X-ray image value as a linear or non-linear function of the X-ray image value and the afterglow value (e.g., to take account of non-linearities in the imaging process). Alternatively, an iterative correction method may be used, for example. It is also possible to take into account the afterglow value or afterglow values ascertained for successive X-ray images within the scope of deconvolution for calculating the X-ray dose actually irradiated onto a respective detector element during the capture of the respective X-ray image. For this purpose, for example, as will be explained later, the algorithm known from the publication by Starman, J., et al. may be extended in order to take account of the dark image values or information about the state of the X-ray detector ascertained based on the dark image values.

If a plurality of X-ray images of an X-ray sequence are to be corrected, in the simplest case, the influence of the X-ray dose irradiated within the scope of this X-ray sequence on the afterglow behavior of the X-ray detector may be disregarded, so that a further decay of the afterglow value may be assumed in accordance with the decay behavior already ascertained in order to ascertain the afterglow value. Such an approximation may, for example, be sufficient and expedient if relatively low X-ray doses are irradiated within the X-ray sequence (e.g., when using fluoroscopy), while afterglow from previous imaging with higher doses is to be compensated. However, as will be explained in more detail later, X-ray doses irradiated during an X-ray sequence following the second time interval may also be taken into account to further improve the correction.

For example, the X-ray image and the respective dark image include a plurality of image points (e.g., 128×128 or 256×256 points). For example, each image point of the X-ray image or dark image is assigned to a respective detector element or pixel of the X-ray detector. The X-ray image is captured while the X-ray source irradiates X-rays onto the X-ray detector or onto at least parts of the detector elements of the X-ray detector. For example, the X-rays incident on the X-ray detector may be attenuated by an object to be mapped (e.g., a patient). The X-ray image may, for example, be a medical imaging image (e.g., an individual X-ray recording), an image of a fluoroscopy sequence, or a projection recording within the scope of computed tomography.

X-rays may always be irradiated onto the X-ray detector when the X-ray source is active. However, it is also possible that the irradiation of the X-rays onto the X-ray detector may be interrupted (e.g., by a shutter and/or by relative pivoting and/or shifting of the X-ray source and X-ray detector relative to one another) while the X-ray source is active.

The afterglow value may be ascertained for the respective image point in dependence on at least one respective derivative value of a first time derivative and/or second time derivative of a temporal image value profile. The respective temporal image value profile is specified in dependence on the dark image values for the respective image point. It has been recognized that a particularly robust prediction is possible by using first time derivatives and/or second time derivatives of the temporal image value profile describing the dark image values of the respective image point. This results from the physical principles of the afterglow, which are explained below by way of example with reference to a silicon detector. However, other detectors or scintillators likewise have corresponding mechanisms for charge trapping so that the following discussion may be transferred to these systems, at least with regard to their relevance for the method described.

In crystalline semiconductors (CMOS), defects form monoenergetic states in the semiconductor's band gap. In equilibrium, these are occupied or unoccupied according to the Fermi level. Charging and discharging processes (e.g., the irradiation of photons onto the respective detector element) cause defect states to assume a non-equilibrium state and then return to the equilibrium state (e.g., thermally, such as phonon-assisted). In crystalline silicon, the number of defects is very low so that CMOS-based detectors exhibit a low afterglow, also known as lag. In contrast, amorphous silicon detectors exhibit pronounced sidebands, which may lead to a longer afterglow. Since the sidebands are formed from local lattice variations, the states are localized, and the charge carriers are thus not mobile. In addition, the non-bonding states of the binding sp³ hybrid orbitals (e.g., dangling bonds) may be located approximately in the middle of the band gap.

Since the defects in the center of the band gap have a significantly higher time constant than the localized sidebands or defects due to their energetic position, the decay of the afterglow cannot usually be described by a single temporally constant decay coefficient. Instead, depending on the irradiated dose or the initial occupation state of the defects, different decay profiles result with a respective time-varying decay rate.

As will be explained in more detail later, the evaluation of the plurality of dark images (e.g., by taking into account the various time derivatives of the image value profile in the second time interval in which no X-rays occur) may be used to recognize where and on which of the possible decay curves the current state of the detector element is located, so that future decay states and, thus also the afterglow value at the time of the X-ray recording, may be robustly predicted.

In the simplest case, the dark images may be captured at a fixed time interval from one another, so that the temporal image value profile may be specified directly by a sequence of the dark image values for the respective image point ordered according to the temporal sequence of the recordings of the dark images. The time derivatives may then be calculated as the respective difference quotient. However, the image value profile may, for example, be determined as an analytical function (e.g., by a fit) or with the aid of resampling.

As will be explained later, in addition to the dark image values, the temporal image value profile may also include one or more further image values (e.g., a respective reference image value from at least one reference image captured before the second time interval); the capture of this will be explained later. If a second time derivative is to be evaluated, the temporal image value profile may include at least three dark image values or at least two dark image values, and in addition a further such image value.

A plurality of possible decay behaviors may in each case describe a model image value profile for the dark image values of the respective image point and/or a first time derivative and/or a second time derivative of the respective model image value profile. One of the decay behaviors is selected in dependence on the derivative value, or at least one of the derivative values for the respective image point and the afterglow value is ascertained in dependence on the selected decay behavior.

Different X-ray doses irradiated onto the individual detector elements or different temporal profiles of the dose irradiation lead to a different occupancy distribution of the various defects, such as, for example, the above-described defects in the center of the band gap and localized sidebands. However, it has been recognized that it is typically sufficient to take account of the decay behaviors for various initial doses as possible decay behaviors, since, for conventional X-ray detectors, all relevant excitation histories lead to a decay behavior that may also be modeled by an excitation profile resulting from a single excitation profile. As already explained, starting from a specific excitation state, this results in superimposed decay processes at different speeds, which may be combined to form a time-varying decay rate and thus a specific decay behavior.

Therefore, the temporal profile of the decay rate and thus the overall decay behavior depend on the initially irradiated dose or the temporal profile of the dose irradiation. This may be taken into account by taking into account different possible decay behaviors. Since the different occupancies of the various defect types with different energies lead to different shapes of the model image value profiles, the decay behavior that most closely corresponds to the decay behavior resulting from the actual state of the respective detector element may be identified and selected by comparing the derivative values with the derivatives of the various model image value profiles.

Since, in some circumstances, the image value profile may be subject to an at least approximately constant offset, it is advantageous to rely only or at least primarily on the derivative values when ascertaining the actual state of the detector element. For example, it may be ascertained based on the first time derivative which point in time on the respective model image value profile corresponds to the current state of the detector element, while the selected model image value profile may be determined based on the second time derivative.

The respective model image value profile or the profile of its first time derivative and/or second time derivative may be specified explicitly by the decay behavior (e.g., as a table of values) or implicitly (e.g., by an analytical function that may depend on one or more parameters, such as on an irradiated X-ray dose). In the simplest case, a possible decay behavior in each case assigns a model value for the image value to various times or a derivative value to the respective time derivative. However, it is also possible for a respective probability distribution of the model values or the derivative values to be assigned to the various times (e.g., by specifying a mean value and a standard deviation in each case).

In principle, it is possible to use the same possible decay behaviors for all image points. However, since the properties of the various detector elements may differ from one another, it may be advantageous in each case to specify separate possible decay behaviors for the individual image points or at least for a plurality of subgroups of the image points.

The possible decay behaviors may, for example, be ascertained within the scope of preliminary tests. For example, measured data relating to the respective decay behavior of the image value of the respective image point may be measured for different irradiated X-ray doses. The measured values may then be used directly (e.g., as a respective table of values) to describe the possible decay behaviors. However, it is, for example, also possible to ascertain the above-mentioned probability distributions based on the measured data obtained from a plurality of measurements or to parameterize a specified model using one or more measurements and thus arrive at a partially empirical model that specifies the possible decay behaviors. Alternatively, it would also be possible to provide such a model solely based on theoretical considerations without experimental data.

The use of a parameterized model may, for example, be provided for enabling the use of a quasi-continuous curve field of model image value profiles between which quasi-continuous fading may be performed by using one or more parameters (e.g., using the dose). In this case, the number of decay behaviors taken into account is potentially limited only by the resolution of the at least one parameter parametrizing the model.

In principle, the possible decay behaviors may be ascertained separately for each detector (e.g., within the scope of calibration during or after its manufacture). However, it is typically sufficient to capture the possible decay behaviors for a specific type of X-ray detector and to use it for all X-ray detectors of this type (e.g., all X-ray detectors of a specific series).

Optionally, ageing of the X-ray detector may be taken into account. For example, the possible decay behaviors may be updated after a certain period of operation, such as within the scope of maintenance, using a new measurement and/or by taking into account a measure of the period of operation (e.g., the value of an operating hours counter) in order to select between various possible decay behaviors for specifying the time derivatives or to adapt a parameterization of the evaluation of the respective decay behavior.

The respective possible decay behavior may in each case be based on a sequence of reference images that are captured sequentially within a third time interval following the irradiation of a respective specified X-ray dose onto the X-ray detector or a further X-ray detector by the X-ray detector or the further X-ray detector. The sequence of reference images thus describes for the at least one detector element of the X-ray detector or the further X-ray detector a respective temporal change of a reference image value of the respective detector element due to the decay of the excitation of the detector element by the irradiated

X-ray dose. In one embodiment, mutually different specified X-ray doses may be irradiated in order to specify separate possible decay behaviors.

The evaluation of the data of the X-ray detector itself may be used to ascertain the possible decay behaviors for the individual X-ray detector. However, as already mentioned, it may be sufficient to determine the possible decay behaviors for a series of X-ray detectors or for a specific type of X-ray detector, which is why data from another X-ray detector may be evaluated in order to determine possible decay behaviors for the X-ray detector.

During the third time interval, for example, no further X-ray dose is irradiated on the X-ray detector or the further X-ray detector. Thus, the decay behavior of the excitation is captured separately for different irradiated X-ray doses and thus for different excitation states. According to this, as explained above, it may be recognized, based on at least one of the time derivatives, the decay curve, and thus the model image value profile, which of the decay behaviors most closely corresponds to the temporal image value profile in order to predict the afterglow value.

With the procedure explained above, the sequence of reference images may also be ascertained multiple times for the same specified X-ray dose, so that the temporal profile of the reference image value or the derivatives thereof may be evaluated statistically, for example, to parameterize a stochastic model or to ascertain a respective probability distribution for the derivative values and/or other variables for various points in time of the respective decay behavior.

The respective afterglow value may be ascertained in dependence on at least one respective decay parameter that is ascertained by optimizing a cost function for the respective image point. The respective derivative value for the first time derivative and/or the second time derivative of the temporal image value profile is in each case ascertained for a plurality of points in time in the second time interval. A decay model in dependence on at least one decay parameter specifies a predicted value for the respective derivative value at the respective point in time, where the cost function depends on a measure of the deviations of the predicted values from the derivative values, or specifies a probability distribution for the respective derivative value at the respective point in time, where the cost function depends on the result of a likelihood function that indicates the probability of a joint occurrence of the respective derivative values at the plurality of points in time in accordance with the specified probability distributions.

If the cost function in the first case only includes the measure of the deviation and is minimized, this corresponds to a minimization of the deviation of the temporal profile of the predicted values from the temporal profile of the derivative values. If quasi-continuous decay parameters are used, this ultimately corresponds to a fit of the decay model to the derivative values.

In the second case, the exclusive use of the likelihood function as a cost function when maximizing the cost function corresponds to the use of the maximum likelihood method known from other areas of application.

Through additional dependencies of the cost function (e.g., by using a weighted sum in which one summand depends on the measure of the deviation or the likelihood function, and at least one further summand depends on other influencing variables), additional information may be taken into account (e.g., as will be explained in more detail later, image values of an X-ray recording taken before the second time interval).

The decay model may, for example, be defined by various possible decay behaviors explained above. In this case, for example, one of the decay parameters may select one of the possible decay behaviors, while a further one of the decay parameters selects a time offset on the model image value profile defined by the selected decay behavior.

The respective corrected X-ray image value may additionally be ascertained for the respective image point in dependence on a respective reference image value of a reference image, where the reference image is based on imaging by the X-ray detector that takes place before the second time interval and during which X-rays are irradiated onto the X-ray detector by the X-ray source.

The reference image value may be regarded as an approximate measure of the last X-ray dose irradiated before the start of the second time interval. If it is initially assumed that the X-ray doses used in previous X-ray imaging were not too high and no saturation of the X-ray detector occurs, an irradiated dose may be determined based on the reference image value, and thus, the decay behavior assigned to this may be selected in order to predict the afterglow value. However, an afterglow value predicted with this fairly simple approach may be subject to significant errors, since the afterglow value disregards the previous history of the detector element (e.g., an X-ray dose irradiated before the reference image and a resulting occupancy of defect states), as well as possible saturation in the reference image.

The procedure explained above may therefore be modified such that, as explained above, one possible decay behavior of a plurality of possible decay behaviors is initially selected based on the reference image value. As soon as at least one dark image has been captured, the current first time derivative may be ascertained (e.g., in the simplest case, as the difference quotient between the reference image value and the subsequent dark image value or between successive dark image values) in order to ascertain, based on this first time derivative, which point in time on the specified model image value profile specified by the selected decay behavior most closely corresponds to the current state of the detector element. In one embodiment, the adjustment of the point in time may be repeated iteratively with each captured dark image value, where the correction of the point in time may be scaled based on the first time derivatives, for example, in order to match the assumed decay behavior to the actual decay behavior (e.g., in the manner of proportional control).

As soon as at least two dark images have been captured, the second time derivative of the image value may be additionally used to potentially select on this basis a different decay behavior than the previously assumed decay behavior. As already explained above, the different decay behaviors may, for example, be assigned to different initially irradiated X-ray doses. For example, thus, a deviation of the initial dose between the previously assumed decay behavior, and thus the previously assumed initial dose and the initial dose of the decay behavior selected based on second time derivative, may be scaled and added to the previously assumed initial dose in order to select a new assumed initial dose and a decay behavior assigned thereto.

The above-described iterative procedure may, for example, be provided if an afterglow value is to be available with little effort within a few dark images in order to correct subsequent X-ray imaging. However, in many applications, dark images may be captured over relatively long periods of time, whereby a plurality of dark image values is provided for each image point. In these cases, it may be advantageous to use one of the above-explained optimization approaches instead of the above-explained iterative approach. However, the robustness and accuracy of these optimization approaches may potentially be further improved if the cost function also depends on the reference image value. In this case, the reference image value may, for example, be included in the temporal image value profile. Alternatively or additionally, for example, a measure of the deviation of an initial dose assigned to the reference image value from an initial dose assigned to the decay behavior selected during optimization may be taken into account as an additional term of a cost function to be optimized that is formed by a weighted sum.

Within the scope of the method according to the present embodiments, it is also possible to correct a further X-ray image that is based on imaging by the X-ray facility after the X-ray image has been captured, and indicates a respective further X-ray image value for at least one image point. The further X-ray image may be corrected by ascertaining a respective further corrected X-ray image value for the respective image point in the further X-ray image in dependence on the respective further X-ray image value, the X-ray image value in the same image point of the X-ray image, and the respective afterglow value for this image point of the X-ray image and/or the dark image values of a plurality of dark images for this image point.

The X-ray image and the further X-ray image may be part of an imaging sequence and may, for example, be captured one after the other in a short time interval (e.g., within the scope of a fluoroscopy sequence). Additionally, taking account of the X-ray image value in the same image point of the X-ray image also enables an afterglow due to a dose previously irradiated during this X-ray sequence to be also taken into account. To enable this to be taken into account, including for an X-ray sequence with more than two X-ray images, in each case, the X-ray image values of all previously captured X-ray images or a specified number of previously captured X-ray images may be taken into account for the subsequent X-ray images.

In the simplest case, the correction based on the afterglow value or the dark image values and the correction based on X-ray image values previously captured within the same X-ray sequence may take place independently of one another. For example, a separate afterglow value may initially be ascertained for each X-ray image in the sequence depending on the dark image values and the temporal position of the respective X-ray image relative to the dark images, and a correction may be made on this basis, as already explained above for the X-ray image. Subsequently, the afterglow may be corrected based on a dose irradiated within the sequence; known algorithms may be used for this purpose (e.g., the deconvolution method disclosed in the above-cited publication by Starman, J., et al.).

However, in one embodiment, a joint correction may be performed for both afterglow effects. In one embodiment, it is, for example, possible to use the deconvolution algorithm used according to equations (12) to (16) in Starman, J., et al., which takes into account a charge state q_{n,k} of the respective detector element present before the start of the capturing of this X-ray image during the deconvolution of a respective X-ray image. Since, as explained above, the evaluation of the plurality of dark images may be used to ascertain where and on which of the possible decay curves the current state of the respective detector element is located, the charge state is at least approximately known or correlates in a known manner with the ascertained afterglow value. Thus, the evaluation of the dark images enables the initial charge state to be ascertained before the first X-ray image of the sequence is captured. After this, the deconvolution algorithm used in Starman, J., et al. may be used with this initial charge for the subsequent further X-ray images.

In the scope of the correction of the X-ray image or the creation of the X-ray image from raw data of the X-ray detector and/or the correction or creation of a subsequent X-ray image, an offset correction of the respective X-ray image value or corrected X-ray image value may take place in dependence on a specified offset value for the respective image point. For example, when an update condition is fulfilled, the offset value may, for example, be set to an updated value that is ascertained in dependence on the dark image values of a subgroup of the dark images for the respective image point. The update condition for the subgroup may only be fulfilled if a further afterglow value that is ascertained for the respective image point of the dark image of the subgroup that was captured earliest in time in dependence on the dark image values of a plurality of previously captured dark images reaches or falls below a specified limit value.

Offset correction of X-ray images, which may, for example, be used to correct temperature-dependent and/or age-related offsets, is known per se. To determine or update the offset value, to date, previous dark image values of dark images are evaluated. However, the described procedure may provide that the only dark images taken into account when ascertaining the offset value are those in which, at least for the image point under consideration in each case, no impairment, or at most a very slight impairment, of the dark image value is to be expected due to afterglow caused by a previously irradiated X-ray dose. The further afterglow value may be ascertained in the same way as explained above for the afterglow value for the X-ray image.

In addition to the method according to the present embodiments, the present embodiments relate to a processing apparatus that is configured to perform the computer-implemented method according to the present embodiments. The processing apparatus may, for example, be configured as suitably programmed data processing facilities, or the functionality may alternatively be at least partially hard-wired. The processing apparatus may be integrated into a medical imaging facility (e.g., into an X-ray facility or embodied separately therefrom). The processing apparatus may, for example, be implemented as a workstation computer, server, or cloud solution.

In addition, the present embodiments relate to an X-ray facility with an X-ray source and an imaging X-ray detector including a processing facility according to the present embodiments. The integration of a processing facility according to the present embodiments and thus the implementation of the method according to the present embodiments in an X-ray facility enables the above-explained afterglow correction to take place directly within the scope of data capture or visualization by the X-ray facility for a user.

The present embodiments also relate to a computer program with instructions configured to perform the computer-implemented method according to the present embodiments when executed on a data processing apparatus.

In addition, the present embodiments relate to a data carrier (e.g., a non-transitory computer-readable storage medium) including the computer program according to the present embodiments.

In the above description, independent of the grammatical term usage, individuals with male, female, or other gender identities are included within the term.

### BRIEF DESCRIPTION OF THE DRAWINGS

Further advantages and details of the invention emerge from the following example embodiments and the associated drawings.

FIG. 1 is a flowchart of an example embodiment of a computer-implemented method for correcting an X-ray image;

FIG. 2 shows an example embodiment of an X-ray facility including an example embodiment of a processing facility;

FIG. 3 illustrates ascertaining various possible decay behaviors of detector elements of an X-ray detector that may be used in the method illustrated in FIG. 1; and

FIG. 4 illustrates additional acts that may be used in the method shown in FIG. 1 to update an offset value used to correct the X-ray image or subsequent X-ray images.

### DETAILED DESCRIPTION

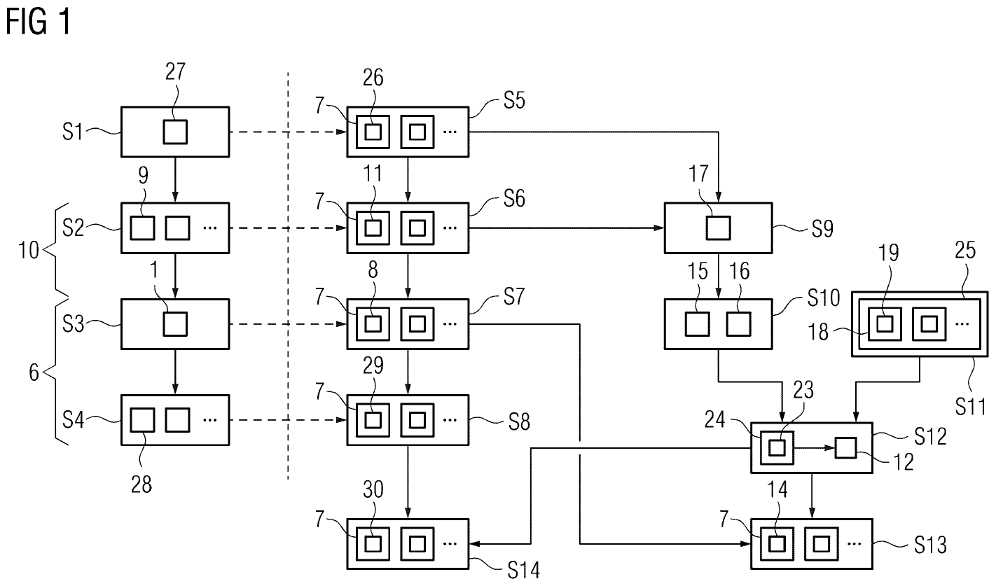

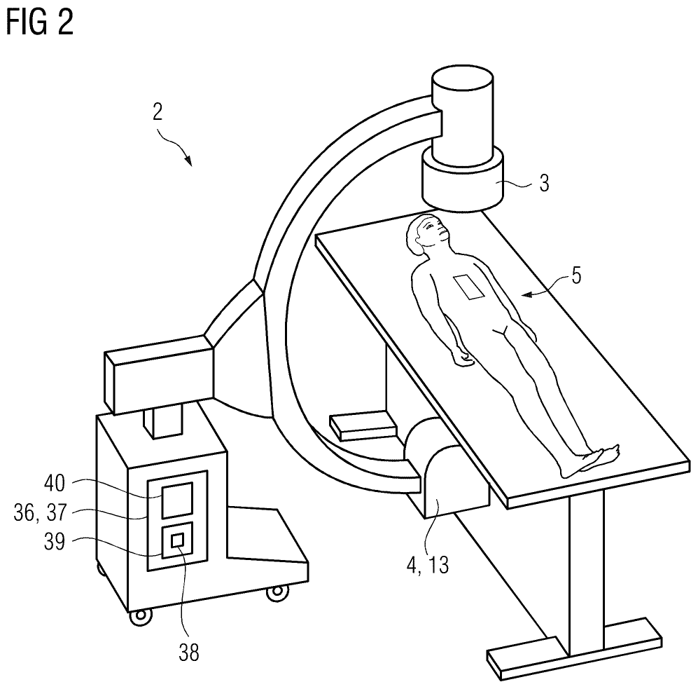

FIG. 1 shows a flowchart of a method for correcting an X-ray image 1. By way of example, it is assumed that the method is implemented by the processing facility 36 depicted in FIG. 2, which is integrated into an X-ray facility 2. As already explained, such a processing facility 36 may also be configured separately from the X-ray facility 2 (e.g., as a server, cloud solution, or workstation computer).

As will be explained in more detail below with reference to the example embodiment of the method depicted in FIG. 1, the X-ray image 1 to be corrected is based on imaging by an imaging X-ray detector 4 of the X-ray facility 2 that took place during a first time interval 6 during which X-rays were irradiated onto the X-ray detector 4 or its detector elements 13 by an X-ray source 3 of the X-ray facility 2. To correct the X-ray image 1, a plurality of dark images 9 are taken into account. The respective dark image 9 is captured by the X-ray detector 4 during a respective subinterval of a second time interval 10 preceding the first time interval 6 during which no X-rays are irradiated onto the X-ray detector 4.

For the respective image point 7 in the X-ray image 1, an afterglow value 12 that is expected to be the X-ray image value 8 in the event that no X-rays are incident on the detector element 13 assigned to the respective image point 7 even after the second time interval 10 is then predicted in each case in dependence on the dark images 9. Thus, the decay behavior of an afterglow due to a previously irradiated X-ray dose may be detected based on the dark images 9, and based on this decay behavior, an afterglow may be predicted at the time the X-ray image 1 is captured. The X-ray image 1 may then be corrected based on the ascertained afterglow values 12.

As indicated in FIG. 1 by the vertical dashed line, the method depicted may be divided into two parts, which may in principle be implemented independently of one another (e.g., even at a large interval from one another and/or by separate apparatuses). In one embodiment, acts S1 to S4 relate to data capture by the X-ray facility 2 itself, while acts S5 to S14 implement the correction method and may, for example, be implemented by executing a computer program 38 implementing the method on a data processing apparatus 37. However, it may also, for example, be possible for the X-ray images 1 28 to be corrected directly after their capture. In this case, acts S4, S8 and S14 performed to capture and correct the further X-ray images 28 may, for example, also only be performed after the further acts depicted.

As shown schematically in FIG. 2, the method in the example is implemented or the processing facility 36 in the example is implemented in that a memory 39 stores a suitable computer program 38, the instructions of which are executed by a processor 40 for implementing the method.

In the example shown in FIG. 1, a reference image 27 is first captured in act S1. The reference image 27 may, for example, be the last X-ray image in an X-ray sequence that was completed before the X-ray image 1 to be corrected was captured. Like the capture of the X-ray images 1 and 28 explained below, the reference image 27 is captured while the X-ray source 3 of the X-ray facility 2 is active, and thus, an X-ray dose is irradiated onto the X-ray detector 4 or its detector elements 13. In the example, a patient 5 is mapped or irradiated. In one embodiment, the reference image 27 may relate to the same patient 5 as the X-ray image 1 that is subsequently captured and is to be corrected; however, different patients 5 or generally different objects may be mapped in the reference image 27 and the X-ray image 1.

In act S2, a plurality of dark images 9 is then captured during a second time interval 10 preceding the first time interval 6 during which the X-ray image 1 is captured. No X-rays are irradiated onto the X-ray detector 4 by the X-ray source 3 during the second time interval 6.

In act S3, the X-ray image 1 is then captured, and further X-ray images 28 to be corrected may be captured in act S4.

In acts S5 to S8, the data captured in acts S1 to S4 is received. In one embodiment, reception may be provision to a specific function or a specific algorithm within a computer program, but, alternatively, also, for example, transmission between various facilities.

In one embodiment, in act S5, the reference image 27 and thus the reference image values 26 for the individual image points 7 of the reference image 27 are received. Accordingly, the dark images 9 and thus the dark image values 11 of the individual image points 7 of the individual dark images 9 are received in act S6. In act S7, the X-ray image 1 and thus the X-ray image values 8 of the individual image points 7 of the X-ray image 1 are received, and in act S8, the further X-ray images 28 and thus the further X-ray image values 29 for the image points 7 of the further X-ray images 28 are received.

In the example, the dark image values 11 for a respective image point 7 are arranged in the order in which their dark images 9 are captured to form a temporal image value profile 17. In addition, in the example, the reference image value 26 for the respective image point 7 precedes the dark image values 11 in the temporal image value profile 17, so that the temporal image value profile 17 describes the decay of the afterglow after the capture of the reference image 27 or the irradiation of the X-ray dose within the scope of previous imaging.

As already discussed in the general part, noticeably different image values may occur due to constants or slowly changing offsets with essentially identical decay processes. To enable better comparability of the temporal image value profile 17 with various possible decay behaviors 18, in each case, a first derivative value 15 is therefore ascertained in act S10 for a plurality of points in time (e.g., for the capture times of the dark images 9 as a first time derivative of the temporal image value profile 17), and a second derivative value 16 is ascertained as a second time derivative of the image value profile 17.

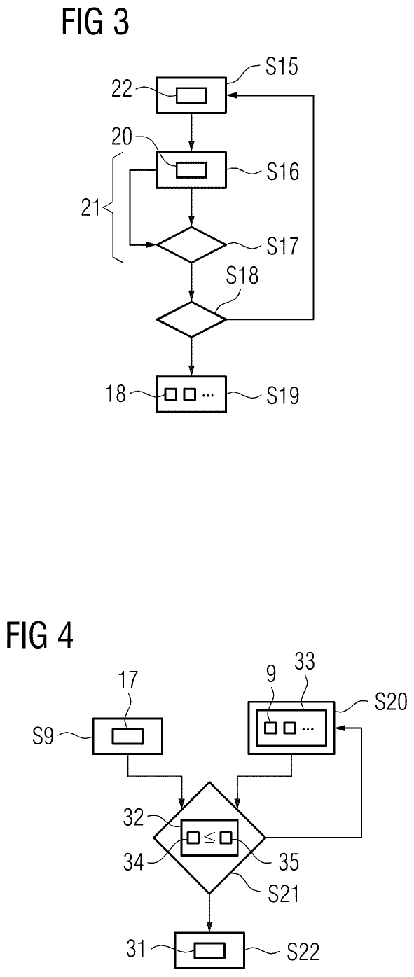

In act S11, a decay model 25 is provided that, in the example, specifies a predicted value in dependence on a plurality of decay parameters 23 for the respective derivative value 15, 16 at the respective point in time. In the example, the decay model includes a plurality of possible decay behaviors 18 that in each case specify a model image value profile 19 for the dark image values 11 of the respective image point 7. One possibility for ascertaining such decay behaviors 18 will be explained later with reference to FIG. 3.

Using a first time derivative and a second time derivative, the respective model image value profile 18 may thus be compared with the ascertained profile of the derivative values 15, 16. In this embodiment of the decay model 25, one of the decay behaviors 18 may be selected by one of the decay parameters, and a time offset between the respective model image value profile 19 and the temporal image value profile 17 may be set by a further one of the decay parameters 23.

In act S12, a cost function 24 is then minimized in the example by varying the decay parameters 23; this depends on a measure of the deviations of the predicted values of the derivative values 15, 16. In other words, by selecting one of the decay behaviors 18 and thus one of the possible model image value profiles 19 and varying the time offset, a section of one of the model image value profiles 19 that corresponds as well as possible to the temporal image value profile 19 in terms of its derivatives is sought.

The value of the selected model image value profile 19 that corresponds to the time of imaging of the X-ray image 1 modified according to the ascertained time offset may then be used as the afterglow value 12.

As already described in the general part, it is also possible for the cost function 24 to depend on further variables. Additionally or alternatively, instead of specifying model image values or their derivatives by the possible decay behaviors 18, in each case, a probability distribution may be specified for each point in time so that the decay parameters 23 may, for example, be ascertained by the maximum likelihood method. In a further alternative embodiment, the afterglow value 12 may be ascertained by selecting the decay behavior and adjusting the time offset iteratively after each capture or after each reception of a dark image 9, as has also already been explained in the general part.

In act 13, the X-ray image 1 is then corrected by ascertaining a respective corrected X-ray image value 14 for the respective image point 7 in dependence on the respective X-ray image value 8 and the respective afterglow value 12. For example, the respective afterglow value 12 may be subtracted from the respective X-ray image value 8 in order to determine the respective corrected X-ray image value 14.

In act S14, the further X-ray images 28 are then corrected by ascertaining a respective further corrected X-ray image value 30 for the respective image point 7. This may substantially take place according to a non-linear consistent stored charge (NLCSC) deconvolution algorithm, as discussed in detail, for example, in the publication by Starman, J., et al., cited in the introduction. The decay parameters 23 ascertained in act S12 may be used to at least approximately ascertain which charge state is present in the detector element 13 assigned to the respective image point 7 before the X-ray image 1 is captured and thus at the beginning of an X-ray sequence including the X-ray image 1 and the further X-ray images 28. Taking account of this initial change in the deconvolution algorithm enables medium-term and long-term afterglow effects (e.g., on a time scale of a plurality of minutes or even more than one hour) resulting from a dose irradiation before the second time interval 10, also to be taken into account.

Figure. 3 shows a possible procedure for ascertaining the possible decay behaviors 18 used in the method according to FIG. 1. For the sake of simplicity, it is assumed in the example that these are ascertained in the X-ray facility 2 itself. However, as already discussed in the general part of the description, possible decay behaviors may also be ascertained for specific types or series of X-ray detectors 4 on an X-ray detector 4 selected by way of example.

In act S15, a specified X-ray dose 22 is initially irradiated onto the X-ray detector 4 by the X-ray source 3. The X-ray dose 22 may, for example, be selected by setting an exposure time.

Within a time interval 21 following this irradiation, a sequence of reference images 20 is then captured in acts S16 and S17. Here, a respective reference image 20 is captured in act S16, and in act S17, it is checked whether a specified number of reference images 20 has already been captured. Once a sufficient number of reference images for the specified X-ray dose 22 has been captured, the method is continued in act S18.

In act S18, it is then checked whether reference images 20 have already been captured for all desired X-ray doses 20. If this is not the case, the method is continued from act S15 with the irradiation of another X-ray dose 22.

Otherwise, a respective possible decay behavior 18 is ascertained in act 19 based on the respective sequence of reference images 20 for the respective specified X-ray dose 22 (e.g., separately for each of the image points 7 or each of the detector elements 13). For example, the respective decay behavior 18 for the respective image point 7 may be specified as a sequence of the reference values that were captured for this image point 7 in the respective sequence of reference images.

For reasons of clarity, a relatively simple method for ascertaining the decay behavior 18 was discussed above. To avoid or reduce the influence of image noise, the respective sequence of reference images 20 may, for example, also be ascertained multiple times, after which the decay behavior may be ascertained by statistical evaluation (e.g., by averaging), or whereby, as already explained above, the various decay behaviors may specify probability distributions for the various times. To avoid the influence of offsets, instead of a sequence of reference values, a first time derivative and/or a second time derivative of these reference values may also be stored directly in order to describe the respective decay behavior 18.

As already mentioned, constant or slowly changing offsets in the individual image points 7 may occur during the capture of X-ray image data; these may be compensated by subtracting an offset value. In one embodiment, it is advantageous to update the offset value during operation (e.g., by averaging image values from a plurality of dark images). One possibility for avoiding the influence of medium-term and long-term afterglow effects is explained below with reference to FIG. 4.

In order to check whether a subgroup 33 of the dark images 9 selected in act S20 is suitable for updating the offset value 31 of a specific image point 7, the procedure depicted in FIG. 4 uses the temporal image value profile ascertained for this image point 7 in act S9 of FIG. 1. For example, the only part of the image value profile evaluated is that relating to the image value profile before the capture of the first dark image 9 of the subgroup 33.

Based on this image value profile, an afterglow value for the respective image point is predicted for the point in time at which the first dark image 9 of subgroup 33 is captured (e.g., in the manner already explained for acts S9 to S12 in FIG. 1).

Only when this afterglow value 34 is smaller than a specified limit value 35 is the update condition 22 fulfilled in act S21, so that the offset value 31 may then be updated in act S22. Otherwise, another subgroup of the dark images 9 is to be selected, or the updating of the offset value 31 is to be postponed, since the afterglow value 34 indicates that the dark images 9 of the subgroup 33 may be at least partially impaired by afterglow, whereby an offset value 31 ascertained based on these dark image values 9 may be falsified.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A computer-implemented method for correcting an X-ray image that is based on imaging by an X-ray facility with an X-ray source and an imaging X-ray detector during a first time interval, and indicates a respective X-ray image value for at least one image point, the computer-implemented method comprising:
receiving the X-ray image;
receiving a plurality of dark images, wherein a respective dark image of the plurality of dark images is based on a respective image data capturing by the imaging X-ray detector during a respective subinterval of a second time interval preceding the first time interval, during which no X-rays are irradiated by the X-ray source onto the imaging X-ray detector, and indicates a respective dark image value for the respective image point;
predicting a respective afterglow value for the respective image point in the X-ray image that is expected as the X-ray image value in the event that no X-rays from the X-ray source are incident on a respective detector element of the imaging X-ray detector assigned to the respective image point even after the second time interval, dependent on the dark image values of dark images of the plurality of dark images for the respective image point; and
correcting the X-ray image, the correcting of the X-ray image comprising ascertaining a respective corrected X-ray image value for the respective image point in dependence on the respective X-ray image value and the respective afterglow value.

2. The computer-implemented method of claim 1, wherein the afterglow value for the respective image point is ascertained in dependence on at least one respective derivative value of a first time derivative, a second time derivative, or the first time derivative and the second time derivative of a temporal image value profile, and
wherein the respective temporal image value profile is specified in dependence on the dark image values for the respective image point.

3. The computer-implemented method of claim 2, wherein a plurality of possible decay behaviors in each case describe a model image value profile for the dark image values of the respective image point, a first time derivative of the respective model image value profiles, a second time derivative of the respective model image value profiles, or any combination thereof,
wherein the computer-implemented method further comprises selecting one decay behavior of the plurality of possible decay behaviors in dependence on the derivative value or at least one of the derivative values for the respective image point, and
wherein the afterglow value is ascertained in dependence on the one selected decay behavior.

4. The computer-implemented method of claim 3, wherein the respective possible decay behavior is in each case based on a sequence of reference images that are captured by the imaging X-ray detector or a further X-ray detector, one after the other in time within a third time interval that follows the irradiation of a respective specified X-ray dose onto the X-ray detector or a further X-ray detector,
wherein the sequence of reference images for at least one detector element of the imaging X-ray detector or the further X-ray detector describes a respective temporal change of a reference image value of the respective detector element due to decay of the excitation of the detector element by the irradiated X-ray dose, and
wherein mutually different specified X-ray doses are irradiated to specify separate possible decay behaviors.

5. The computer-implemented method of claim 2, wherein the respective afterglow value is ascertained in dependence on at least one respective decay parameter that is ascertained by optimizing a cost function for the respective image point,
wherein the respective derivative value for the first time derivative, the second time derivative, or the first time derivative and the second time derivative of the temporal image value profile is in each case ascertained for a plurality of points in time in the second time interval, and
wherein a decay model dependent on at least one decay parameter:
specifies a predicted value for the respective derivative value at the respective point in time, the cost function depending on a measure of the deviations of the predicted values from the derivative values; or
specifies a probability distribution for the respective derivative value at the respective point in time, the cost function depending on a result of a likelihood function that indicates a probability of a joint occurrence of the respective derivative values at the plurality of points in time in accordance with the specified probability distributions.

6. The computer-implemented method of claim 1, wherein the respective corrected X-ray image value for the respective image point is additionally ascertained in dependence on a respective reference image value of a reference image, and
wherein the reference image is based on imaging by the imaging X-ray detector that takes place before the second time interval and during which X-rays are irradiated onto the imaging X-ray detector by the X-ray source.

7. The computer-implemented method of claim 1, further comprising correcting a further X-ray image that is based on imaging by the X-ray facility after capturing the X-ray image, the further X-ray image indicating a respective further X-ray image value for at least one image point,
wherein correcting the further X-ray image comprises ascertaining a respective further corrected X-ray image value for the respective image point in the further X-ray image in dependence on the respective further X-ray image value, of the X-ray image value in the same image point of the X-ray image, and the respective afterglow value for the image point of the X-ray image, the dark image values of dark images of the plurality of dark images for the image point, or a combination thereof.

8. The computer-implemented method of claim 1, wherein, within the scope of the correction of the X-ray image or creation of the X-ray image from raw data of the imaging X-ray detector, the correction or creation of a subsequent X-ray image, or a combination thereof, an offset correction of the respective X-ray image value or corrected X-ray image value is carried out in dependence on a specified offset value for the respective image point,
wherein when an update condition is fulfilled, the offset value is set to an updated value that is ascertained in dependence on the dark image values of a subgroup of dark images of the plurality of dark images for the respective image point, and
wherein the update condition for the subgroup is only fulfillable when a further afterglow value that is ascertained for the respective image point for the dark image of the subgroup captured earliest in time in dependence on the dark image values of a plurality of previously captured dark images reaches or falls below a specified limit value.

9. A processing apparatus comprising:
a processor configured to correct an X-ray image that is based on imaging by an X-ray facility with an X-ray source and an imaging X-ray detector during a first time interval, and indicates a respective X-ray image value for at least one image point, the processor being configured to correct the X-ray image comprising the processor being configured to:
receive the X-ray image;
receive a plurality of dark images, wherein a respective dark image of the plurality of dark images is based on a respective image data capturing by the imaging X-ray detector during a respective subinterval of a second time interval preceding the first time interval, during which no X-rays are irradiated by the X-ray source onto the imaging X-ray detector, and indicates a respective dark image value for the respective image point;
predict a respective afterglow value for the respective image point in the X-ray image that is expected as the X-ray image value in the event that no X-rays from the X-ray source are incident on a respective detector element of the imaging X-ray detector assigned to the respective image point even after the second time interval, dependent on the dark image values of dark images of the plurality of dark images for the respective image point; and
correct the X-ray image, the correction of the X-ray image comprising ascertainment of a respective corrected X-ray image value for the respective image point in dependence on the respective X-ray image value and the respective afterglow value.

10. An X-ray facility comprising:
an X-ray source;
an imaging X-ray detector; and
a processing apparatus comprising:
a processor configured to correct an X-ray image that is based on imaging by the X-ray facility with the X-ray source and the imaging X-ray detector during a first time interval, and indicates a respective X-ray image value for at least one image point, the processor being configured to correct the X-ray image comprising the processor being configured to:
receive the X-ray image;
receive a plurality of dark images, wherein a respective dark image of the plurality of dark images is based on a respective image data capturing by the imaging X-ray detector during a respective subinterval of a second time interval preceding the first time interval, during which no X-rays are irradiated by the X-ray source onto the imaging X-ray detector, and indicates a respective dark image value for the respective image point;
predict a respective afterglow value for the respective image point in the X-ray image that is expected as the X-ray image value in the event that no X-rays from the X-ray source are incident on a respective detector element of the imaging X-ray detector assigned to the respective image point even after the second time interval, dependent on the dark image values of dark images of the plurality of dark images for the respective image point; and
correct the X-ray image, the correction of the X-ray image comprising ascertainment of a respective corrected X-ray image value for the respective image point in dependence on the respective X-ray image value and the respective afterglow value.

11. In a non-transitory computer-readable storage medium that stores instructions executable by one or more processors to correcting an X-ray image that is based on imaging by an X-ray facility with an X-ray source and an imaging X-ray detector during a first time interval, and indicates a respective X-ray image value for at least one image point, the instructions comprising:
receiving the X-ray image;
receiving a plurality of dark images, wherein a respective dark image of the plurality of dark images is based on a respective image data capturing by the imaging X-ray detector during a respective subinterval of a second time interval preceding the first time interval, during which no X-rays are irradiated by the X-ray source onto the imaging X-ray detector, and indicates a respective dark image value for the respective image point;
predicting a respective afterglow value for the respective image point in the X-ray image that is expected as the X-ray image value in the event that no X-rays from the X-ray source are incident on a respective detector element of the imaging X-ray detector assigned to the respective image point even after the second time interval, dependent on the dark image values of dark images of the plurality of dark images for the respective image point; and
correcting the X-ray image, the correcting of the X-ray image comprising ascertaining a respective corrected X-ray image value for the respective image point in dependence on the respective X-ray image value and the respective afterglow value.

12. The non-transitory computer-readable storage medium of claim 11, wherein the afterglow value for the respective image point is ascertained in dependence on at least one respective derivative value of a first time derivative, a second time derivative, or the first time derivative and the second time derivative of a temporal image value profile, and
wherein the respective temporal image value profile is specified in dependence on the dark image values for the respective image point.

13. The non-transitory computer-readable storage medium of claim 12, wherein a plurality of possible decay behaviors in each case describe a model image value profile for the dark image values of the respective image point, a first time derivative of the respective model image value profiles, a second time derivative of the respective model image value profiles, or any combination thereof,
wherein the instructions further comprise selecting one decay behavior of the plurality of possible decay behaviors in dependence on the derivative value or at least one of the derivative values for the respective image point, and
wherein the afterglow value is ascertained in dependence on the one selected decay behavior.

14. The non-transitory computer-readable storage medium of claim 13, wherein the respective possible decay behavior is in each case based on a sequence of reference images that are captured by the imaging X-ray detector or a further X-ray detector, one after the other in time within a third time interval that follows the irradiation of a respective specified X-ray dose onto the X-ray detector or a further X-ray detector,
wherein the sequence of reference images for at least one detector element of the imaging X-ray detector or the further X-ray detector describes a respective temporal change of a reference image value of the respective detector element due to decay of the excitation of the detector element by the irradiated X-ray dose, and
wherein mutually different specified X-ray doses are irradiated to specify separate possible decay behaviors.

15. The non-transitory computer-readable storage medium of claim 12, wherein the respective afterglow value is ascertained in dependence on at least one respective decay parameter that is ascertained by optimizing a cost function for the respective image point,
wherein the respective derivative value for the first time derivative, the second time derivative, or the first time derivative and the second time derivative of the temporal image value profile is in each case ascertained for a plurality of points in time in the second time interval,
wherein a decay model dependent on at least one decay parameter:
specifies a predicted value for the respective derivative value at the respective point in time, the cost function depending on a measure of the deviations of the predicted values from the derivative values; or
specifies a probability distribution for the respective derivative value at the respective point in time, the cost function depending on a result of a likelihood function that indicates a probability of a joint occurrence of the respective derivative values at the plurality of points in time in accordance with the specified probability distributions.

16. The non-transitory computer-readable storage medium of claim 11, wherein the respective corrected X-ray image value for the respective image point is additionally ascertained in dependence on a respective reference image value of a reference image, and
wherein the reference image is based on imaging by the imaging X-ray detector that takes place before the second time interval and during which X-rays are irradiated onto the imaging X-ray detector by the X-ray source.

17. The non-transitory computer-readable storage medium of claim 11, wherein the instructions further comprise correcting a further X-ray image that is based on imaging by the X-ray facility after capturing the X-ray image, the further X-ray image indicating a respective further X-ray image value for at least one image point,
wherein correcting the further X-ray image comprises ascertaining a respective further corrected X-ray image value for the respective image point in the further X-ray image in dependence on the respective further X-ray image value, of the X-ray image value in the same image point of the X-ray image, and the respective afterglow value for the image point of the X-ray image, the dark image values of dark images of the plurality of dark images for the image point, or a combination thereof.

18. The non-transitory computer-readable storage medium of claim 11, wherein, within the scope of the correction of the X-ray image or creation of the X-ray image from raw data of the imaging X-ray detector, the correction or creation of a subsequent X-ray image, or a combination thereof, an offset correction of the respective X-ray image value or corrected X-ray image value is carried out in dependence on a specified offset value for the respective image point,
wherein when an update condition is fulfilled, the offset value is set to an updated value that is ascertained in dependence on the dark image values of a subgroup of dark images of the plurality of dark images for the respective image point, and
wherein the update condition for the subgroup is only fulfillable when a further afterglow value that is ascertained for the respective image point for the dark image of the subgroup captured earliest in time in dependence on the dark image values of a plurality of previously captured dark images reaches or falls below a specified limit value.
